(19) United States
(12) Patent Application Publication
(10) Pub. No.: US 2024/0024938 A1
(43) Pub. Date: Jan. 25, 2024

(54) METHOD AND DEVICE FOR PRODUCING AN EXTRUDED PRODUCT

(71) Applicant: TECHNISCHE UNIVERSITÄT BERLIN, Berlin (DE)

(72) Inventors: Sören MÜLLER, Berlin (DE); René NITSCHKE, Berlin (DE); Sven GALL, Berlin (DE); Felix GENSCH, Hohen Neuendorf (DE)

(73) Assignee: TECHNISCHE UNIVERSITÄT BERLIN, Berlin (DE)

(21) Appl. No.: 18/266,118

(22) PCT Filed: Dec. 9, 2021
(86) PCT No.: PCT/EP2021/085042

§ 371 Date: Jun. 8, 2023

(30) Foreign Application Priority Data
Dec. 11, 2020 (EP) 20213455.7

(51) Int. Cl. B21C 23/22; B21C 23/14

(52) U.S. Cl. CPC B21C 23/22; B21C 23/142

(57) ABSTRACT

The invention relates to a method and a device for producing an extruded product. In the method an extrusion device is provided comprising: a container (7); a first container bore (5), formed in the container (7) and in which a first extrusion punch (10) is arranged; a second container bore (6), formed in the container (7) separately from the first container bore (5) and in which a second extrusion punch (11) is arranged; and a moulding tool (15) with a moulding cavity (14), which are connected to the first and the second container bore (5, 6). The method further comprises the following: arranging a first material billet (8) made of a first material (2) in the first container bore (5); arranging a second material billet (9) made of a second material (3) which differs from the first material (2) in the second container bore (6); and extruding an extruded product (1) in which the first and the second material (2, 3) are connected in a form-fitting and integrally bonded manner, comprising the following: feeding the first extrusion punch (10) in the first container bore (5) in such a manner that the first material (2) is thereby pressed into the moulding cavity (14) of the moulding tool (15) and thereby formed; feeding the second extrusion punch (11) in the second container bore (6) in such a manner that the second material (3) is thereby pressed into the moulding cavity (14) of the moulding tool (15) and thereby formed; and joining the first and second material (2, 3) in a form-fitting and integrally bonded manner to form an extruded product (1) in the moulding tool (15). A first feeding during feeding of the first extrusion punch (10) in the first container bore (5) and a second feeding during feeding of the second extrusion punch (11) in the second container bore (6) are controlled independently of one another.

The invention relates to a method and a device for producing an extruded product.

### BACKGROUND

In the field of bulk forming, extrusion is an energy-efficient method for producing in particular semi-finished products close to the final contour as an extruded product from primary material by means of only one forming step. Various materials can be processed. In addition to light metals such as aluminium, magnesium and titanium, for example, ferrous metals, non-ferrous metals and precious metals as well as alloys thereof can be brought into shape. The process temperatures here can be up to about 1300° C. but can also be below 0° C. The method enables the narrowest dimensional tolerances to be maintained and furthermore enables the chemical and physical properties of the extruded products to be adapted to the specific requirements of the end products via the microstructure. Apart from remelting stock, forged intermediate products and powder materials, for example, are also suitable as starting material.

The increasingly extensive requirement profiles for structural and functional components both in the automotive and in the transport, energy, medicine and air travel sectors is being increasingly met with loading-adapted concepts. These include, in addition to cross-section-optimized geometries, increasingly hybrid concepts in which various materials or alloys are used locally in the component. All these concepts have in common the need for an additional joining process to produce an integrally bonded, frictional or form-fitting connection. This takes place either before or following the shaping close to the final contour.

In order to join metals in a firmly bonded manner to one another, the clean metal surfaces must be brought close to one another as far as an interatomic distance. In this case, both a sufficiently high pressure and a sufficiently high temperature must prevail in order to level out the surface roughness and produce the necessary closeness as well as to enable the diffusion processes necessary for the chemical bond. Since metal surfaces are generally covered with impurities and oxides, the “clean” surfaces must firstly be exposed in order to be able to produce a connection at the atomic level. In order to achieve this, the contact surfaces of the two metal volumes must be enlarged to a sufficient extent. However, the top layers must not be enlarged or only to a very small extent in relation to the contact surface.

One possibility for opening up the surfaces of joining partners consists in shearing these against one another under the influence of normal stresses. Here the surface is kneaded and thereby enlarged with the result that the impurities and oxides open up so that the clean metal surface is exposed. Depending on the level of the shearing introduced, on the one hand, the impurities and oxides can be severely reduced in size and on the other hand, the surface can be significantly enlarged.

Extrusion fundamentally affords the possibility of “pressing” together separate material streams during the forming and thereby producing a joint connection, the so-called extrusion press seam or press seam in the extruded product. The temperatures and pressures required for this as well as a sufficient shearing can be introduced by means of an extrusion process. In this way, different materials and alloys can be joined during extrusion. The extrusion of composites of different metallic materials has been investigated in various studies and the influence of process parameters on the composite properties has been shown. At the extrusion research centre, investigations of the extrusion of material composites have been conducted in the past (cf. Negendank et al., J. Mater Process Tech 212, 2012, 1954; Negendank et al., Key Engineering Materials 554-557, 2013, 767; Nitschke et al., Magnesium—10th International Conference on Magnesium alloys and their applications (Editor: K. U. Kainer), 2015, 478). In this case, it could be shown that material composites can be produced by means of various process variants of extrusion.

Material composites can be produced by means of the hydrostatic extrusion method using an active medium (cf. Ruppin et al., Aluminium 56, 1980, 523). By this means direct contact and therefore solid friction between billets, containers and extrusion punches can be prevented or reduced (cf. Bauser et al., Extrusion, Aluminium-Verlag, Dusseldorf, 2001). For this reason the method has an almost ideal material flow and makes it possible to produce, for example, Cu/Al composites or Cu/Nb₃Sn superconductors. However, the process-technology-dependent expenditure on preparation of the billets (geometric adaptation of the billet front side to seal the container content in the direction of the die) and carrying out the tests (filling the container with the hydrostatic medium, sealing and removal after the pressing process) are very work-intensive, time-consuming and costly.

Cylindrical multi-material billets can be used in compound extrusion. For example, magnesium hybrids can be formed and joined by extrusion. However, the pressing of alloy pairs with significant differences in the forming resistances results in considerable difficulties when setting a homogeneous material flow, which leads to a marked warpage in the profile as far as degradation of the profile in the region of the press seam. Furthermore, severe rotations and displacements of the boundary surface occur relative to the profile cross-section. These effects can depend on the respective volume fractions and the positions of the billet parts (cf. Nitschke et al., Magnesium—10th International Conference on Magnesium alloys and their applications (Editor: Kainer), 2015, 478).

In connection with the coaxial extrusion of aluminium magnesium composites, it has been shown that composites of magnesium and aluminium can be formed and joined by means of extrusion (cf. Negendank et al., J. Mater Process Tech 212, 2012, 1954; Negendank et al., Key Engineering Materials 554-557, 2013, 767).

The document US 2004/074275 A1 describes an extruder bending machine that can bend a product by extruding two or more pig irons. The machine consists of an extrusion die holder which is fitted with conical dies, a container holder that heats the container with two or more holes having conical plugs, two or more extrusion stems, hydraulic unit, relative velocity control unit and support frame structure. When two or more pig iron billets are welded together in a conical die cavity and extruded at the die exit to form a product, the extruder bending machine can bend the extruded part simultaneously during extrusion with the gradient of the extrusion velocities as a result of the relative movement speed of the two or more extrusion stems.

The document JP H04-157014 A discloses a device for extrusion in which die billets made of different materials are inserted into corresponding receiving holes. Extrusion punches are moved by means of a punch which press the materials through a moulding tool whereby they are pressure-welded.

The document US 368,314 A relates to a device for producing bent pipes from a plastic material.

The document JP H07-60340 A discloses an extrusion device in which material is pressed by means of extrusion punches from associated container holes through a moulding tool.

### SUMMARY

It is the object of the invention to provide a method and a device for producing an extruded product by means of which extruded products can be produced more efficiently and more variably.

In order to achieve this, a method and a device for producing an extruded product according to the independent Claims 1 and 11 are provided. Embodiments are the subject matter of the dependent claims.

According to one aspect, a method for producing an extruded product (extrusion molded product) is provided. In this case, an extrusion device is provided comprising the following: a container; a first container bore, formed in the container and in which a first extrusion punch is arranged; a second container bore, formed in the container separately from the first container bore and in which a second extrusion punch is arranged; and a moulding tool with a moulding cavity, which is connected to the first and the second container bore. In the method the following is further provided: arranging a first material billet made of a first material in the first container bore; arranging a second material billet made of a second material which differs from the first material in the second container bore; and extruding an extruded product in which the first and the second material are connected in a form-fitting and integrally bonded manner. The extrusion further comprises the following: feeding the first extrusion punch in the first container bore in such a manner that the first material is thereby pressed into the moulding cavity of the moulding tool and thereby formed; feeding the second extrusion punch in the second container bore in such a manner that the second material is thereby pressed into the moulding cavity of the moulding tool and thereby formed; and joining the first and second material in a form-fitting and integrally bonded manner to form an extruded product in the moulding tool. A first feeding during feeding of the first extrusion punch in the first container bore and a second feeding during feeding of the second extrusion punch in the second container bore are controlled independently of one another.

According to a further aspect, a device for producing an extruded product is provided, comprising the following: a container; a first container bore which is formed in the container and in which an extrusion punch is arranged; a second container bore which is formed in the container separately from the first container bore and in which a second extrusion punch is arranged; and a moulding tool with a moulding cavity which is connected to the first and the second container bore in such a manner that during extrusion by means of feeding the first extrusion punch in the first container bore and feeding the second extrusion punch in the second container bore, a first material of a first material billet from the first container bore and a second material of a second material billet which differs from the first material can be introduced into the moulding cavity from the second container bore to produce an extruded product in which the first and the second material are connected in a form-fitting and integrally bonded manner. In this case, a first feed during feeding of the first extrusion punch in the first container bore and a second feed during feeding of the second extrusion punch in the second container bore can be controlled independently of one another.

The provision of at least two extrusion punches which are arranged in separate container bores makes it possible to operate the extrusion punches independently of one another during extrusion in order to introduce the respective material in the moulding tool by means of feeding.

The movement of the extrusion punches during feeding is usually accomplished in the axial direction of the container bore. The container bores can couple directly onto the moulding cavity of the moulding tool at the ends so that the material passes directly from an outlet of the press channel of the container bore into an inlet of the moulding cavity. The container bores each form a cavity in which the material is subjected to pressing pressure in order to introduce this from the container bore into the moulding tool and thereby mould it.

The container bores can be formed with a cylindrical shape.

In extrusion the materials in the moulding tool can be joined in a form-fitting and integrally bonded manner along a joining connection (joining seam).

The materials can comprise metallic materials of various types, for example, aluminium or magnesium.

The formation of separate container bores with a respective extrusion punch enables feed movements of the extrusion punches in the container bores that are decoupled from one another.

The connecting in an integrally bonded and form-fitting manner can be made in the moulding tool between the first and the second material. The tension between the first and the second material in the moulding cavity can be set and varied by means of the decoupled feed movement of the extrusion punches in the separate container bores.

The first and the second material can be introduced into the moulding cavity at different flow rates. As a result of the adjustability of the various flow rates, it is possible to adapt the extrusion process to different materials. The manufacturing process can thus also be optimized for the requirements for different extruded products. In an alternative process management, the first and second material can be introduced into the moulding cavity at substantially the same flow rate.

The decoupled adjustability or controllability of the feed of the extrusion punch in the separate container bores enables the extrusion process to be adapted individually to different process managements, for example, depending on the materials and/or the extruded product to be produced.

The feeding of the first extrusion punch in the first container bore can carried out at a first feed rate and the feeding of the second extrusion punch in the second container bore can be carried out at a second feed rate which differs from the first feed rate. By means of different feed rates, in particular the flow rates for the materials can be adjusted on transition from the container bore into the moulding cavity of the moulding tool.

During movement in the first container bore the first extrusion punch is driven by means of a first actuator and during movement in the second container bore the second extrusion punch is driven by means of a second actuator which is formed and controllable separately from the first actuator. Alternatively it can be provided to actuate the extrusion punches by means of one actuator that is jointly assigned to the extrusion punches. The common actuator can have decoupled actuator elements which can bring about a decoupled feed movement of the extrusion punches.

A material which differs from the first material is used as the second material. For example, various metallic materials can be used.

An extrusion profile can be produced as an extruded product. The extrusion profile can be produced with any profile cross-sections. Extrusion profiles with axially variable volume fractions of different materials can be produced by means of the method. Furthermore, extruded products having an axially variable cross-section and at the same time, axially variable volume fractions of different materials can be produced with suitable die structures.

An extrusion device can be provided in which the first container bore has a first cross-section and the second container bore has a second cross-section which differs from the first cross-section, transverse to the respective feed direction. In this or other embodiments the container bores can be formed with a round, angular or oval cross-section, in particular circular or different from circular.

Alternatively an extrusion device can be provided in which the first container bore has the first cross-section and the second container bore has the second cross-section which is the same as the first cross-section, transverse to the respective feed direction. The sameness of or difference between the cross-sections can, for example, relate to the total area of the cross-section and/or the shape of the cross-sectional area. An identity of the cross-sections can also be provided, i.e. a sameness of all the cross-sectional properties.

An extrusion device can be provided or used in which the first container bore has a first circular cross-section and the second container bore has a second circular cross-section, transverse to the respective feed direction.

An extrusion device can be provided in which the first container bore and the second container bore are sealed with respect to one another. The container bores can in this case be sealed in a fluid-tight manner with respect to one another, in particular in a liquid-tight manner.

The container bores form a respective receptacle for the extrusion punches (punch receptacle).

The embodiments explained hereinbefore in connection with the method for producing an extruded product can be provided accordingly in connection with the device for producing the extruded product.

By means of the proposed technique it can be provided in one embodiment that the individual material flows homogeneously feed the moulding cavity so that as little shearing as possible is produced in the pressing direction inside the moulding cavity and in the region of the press channel. By this means the contact shear stresses and also the axial elongation differences between the material partners during the joining process can be minimized. A homogeneous strand exit speed over the entire cross-section is achieved and any harmful shearing in the region of the boundary layer is prevented. In other words, this means that material flows having the same flow rate are brought together in the moulding cavity and these can be pressed against one another by a minimum pressure in order to produce a firmly bonded hybrid.

Thus, in one embodiment locally the same material flows can be achieved with different press materials which have different forming resistances and process windows. This cannot be achieved when using a classical extruder with only one extrusion punch. In particular, when using the classical extruder with only one extrusion punch, it is not possible to set the pressure in the regions of the primary forming zone, welding chamber and press channel to the same level in order to prevent boundary layer displacement.

When producing the extruded product, it can be provided to locally adapt the cross-section of extruded composite profiles according to the loadings on parts and components prevailing during use. For example, it can be provided to make the wall thickness of a material responsible for receiving loads in the extruded product thicker in first regions than in more weakly loaded regions (second regions which differ from the first regions) which are then executed with a smaller wall thickness. The development of load-adapted tailored profiles can reduce the weight of extruded components or parts with respect to those that have been reduced by means of the conventional manufacturing process.

### DESCRIPTION OF EXEMPLARY EMBODIMENTS

Further exemplary embodiments are explained hereinafter with reference to figures of a drawing. In the figures:

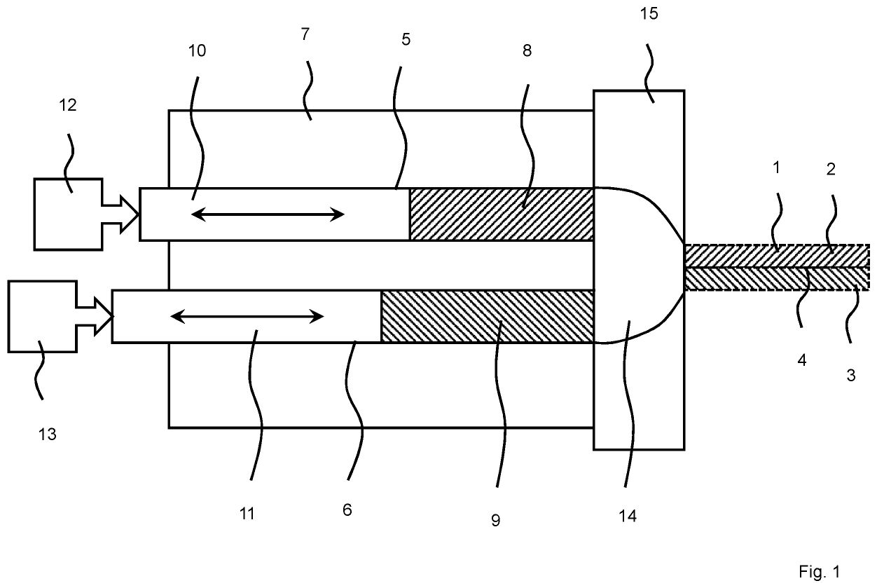

FIG. 1 shows a schematic diagram of a device for producing an extruded product;

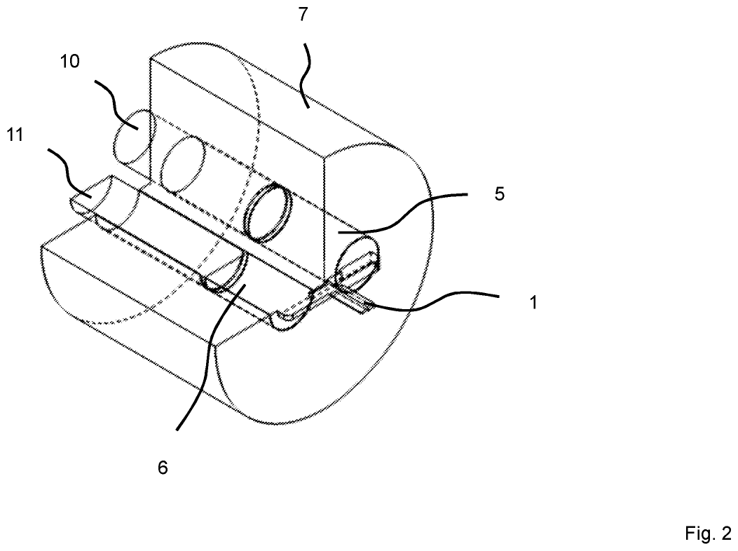

FIG. 2 shows a perspective diagram of a container for an extrusion device in which the first and the second extrusion punch are arranged in the first and the second container bore;

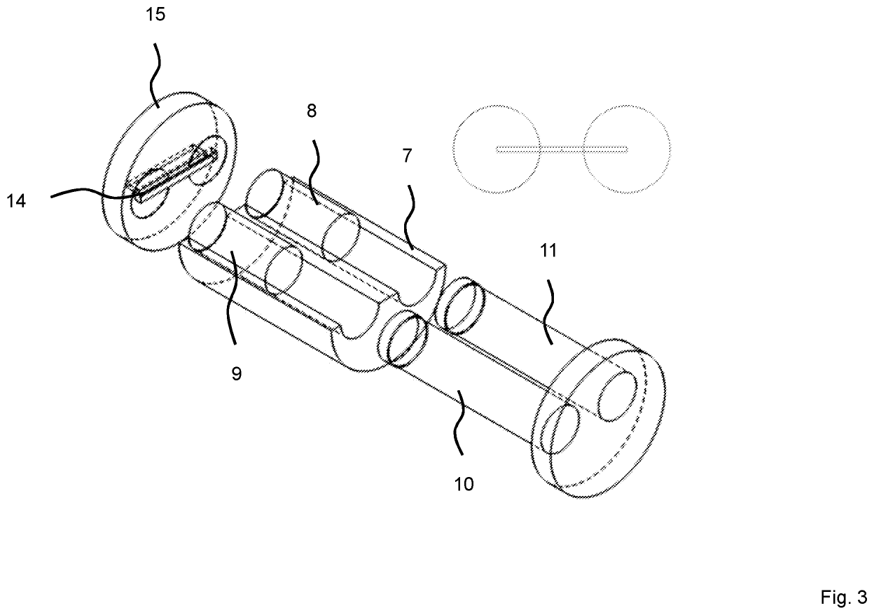

FIG. 3 shows a schematic perspective diagram of an arrangement with two extrusion punches for pressing material billets with the same feed rates;

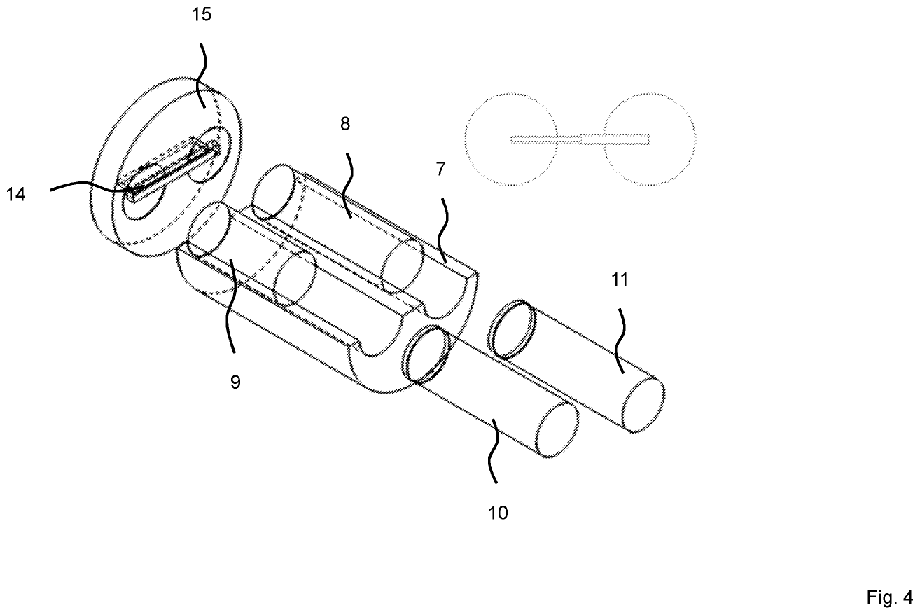

FIG. 4 shows a schematic perspective diagram of an arrangement with two extrusion punches for pressing material billets with different feed rates and

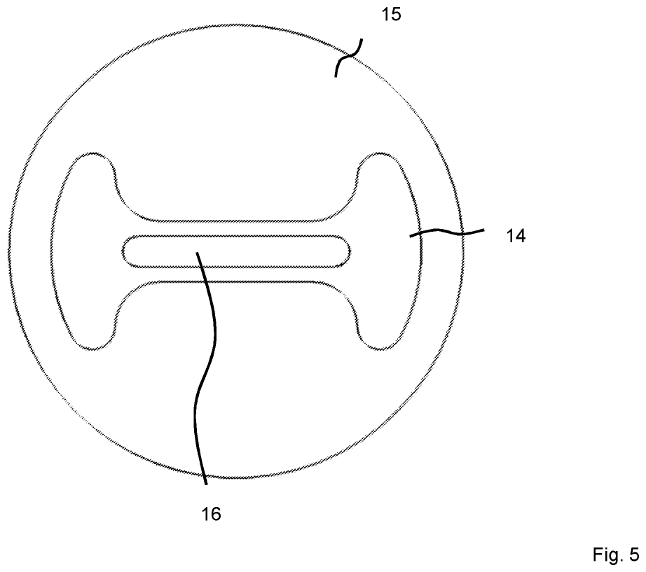

FIG. 5 shows a schematic diagram of a moulding tool from the front.

FIG. 1 shows a schematic diagram of a device for producing an extruded product 1 in which a first material 2 and a second material 3 are joined together in a form-fitting and integrally bonded manner by means of extrusion along a joining connection or seam 4. The extruded product 1 can comprise an extrusion profile.

The formulation “extrusion profile” in the meaning used here comprises all profile geometries that can be produced with the aid of the extrusion process. These include, for example, both solid profiles and also hollow profiles as well as semi-hollow profiles in arbitrary geometries. Thus, for example extruded “sheets” as well as tubes, window profiles or round rods are known as extrusion profiles.

In order to produce the extruded product 1, a first material billet 8 made of a first material 2 and a second material billet 9 made of a second material 3 are arranged in a first and a second container bore 5, 6 of a container 7. The first and the second container bore 5, 6 provide a respective cavity with a cylindrical shape which can have a round, angular or oval cross-section. A first and a second extrusion punch 10, 11 are arranged in the container bores 5, 6, which are each displaceable in the axial direction in the associated container bore 5, 6.

The first and the second extrusion punch 10, 11 are each assigned a first and a second actuator 12, 13 which are adapted to apply force to the respective extrusion punch 10, 11 so that the extrusion punches 10, 11 execute a feed movement in the direction of a moulding cavity 14 of a moulding tool 15 in order to thus introduce the first and the second material 2, 3 into the moulding cavity 14. For this purpose, the first and the second container bore 5, 6 are connected to the moulding cavity 14 in such a manner that the material of the first and the second material billet 8, 9 is introduced in the moulding cavity 14 and is thereby moulded. The application of pressure has the result that the joining connection 4 between the first and the second material 2, 3 is formed in the moulding cavity 14.

With the aid of the first and the second actuator 12, 13 the first and the second extrusion punches 10, 11 can execute decoupled feed movements during extrusion. In particular, the extrusion punches 10, 11 can move at different speeds during feeding. By means of the independent setting of the two feed movements it is possible to set different flow rates for the transition of the first and the second material 2, 3 into the moulding cavity. The first and the second material 2, 3 can, for example, be different metallic materials but the use of the same metallic materials for the two material billets 8, 9 can also be provided. The extruded product 1 produced can be an extrusion profile.

Further exemplary embodiments are explained hereinafter with reference to FIGS. 2 to 5. The same reference numbers as in FIG. 1 are used for the same features.

FIG. 2 shows a schematic diagram of an arrangement for an extrusion device in which extrusion punches 10, 11 having different cross-sections are arranged in the first and the second container bore 5, 6. Whereas the first extrusion punch 10 has a round cross-section, the second extrusion punch 11 is provided with an angular (flat) cross-section. Accordingly, the first and the second container bore 5, 6 have a round and an angular cross-section. In the various embodiments the extrusion punches 10, 11 are arranged in a form-fitting manner in the associated container bore 5, 6. According to FIG. 2, the material billets 8, 9 then have a round and an angular cross-section.

A form-fitting seal can be achieved by means of a so-called “press disk” (not shown) positioned between extrusion punches 10, 11 and material billets 8, 9. This is used both fixedly —in the sense of “constructively temporarily connected to one another but exchangeably”—and loosely.

FIG. 3 shows a schematic diagram of elements of an arrangement for an extrusion device in which the first and the second material billets 8, 9 are formed with the same billet length. The first and the second container bore 5, 6 also have the same cross-section. During extrusion it can then be provided to operate the first and the second extrusion punches 10, 11 at the same feed rate.

In contrast, FIG. 4 shows a schematic diagram of elements for an arrangement of an extrusion device in which the first and the second material billets 8, 9 are formed with different length. During extrusion the first extrusion punch 10 can then be operated at a different feed rate from the second extrusion punch 11.

In order to position the container 7 and the moulding tool 15 with the moulding cavity 14 relative to one another during the actual extrusion process, it can be provided to form constructive elements (not shown) assigned to one another on the container 7 and on the moulding tool 15. When joining together container 1 and moulding tool 15 in such a manner that the moulding cavity 14 of the first and the second container bore 5, 6 are arranged opposite one another, container 1 and moulding tool 15 are positioned relative to one another whereby a pin or a billet (not shown) engage in provided recesses or functional surfaces are aligned relative to one another.

FIG. 5 shows a schematic diagram of an embodiment of the moulding tool 15 from the front. The extruded product leaves the moulding cavity 14 through an (outlet) of the press channel 16 during operation during extrusion.

Aspects for further exemplary embodiments are explained hereinafter.

The method for hybrid extrusion by means of the multi-punch system uses, for example, the previously explained double-punch design with the multi-hole recipient or container 7 having the at least two cavities for the container bores 5, 6 and the corresponding number of individually movable and controllable extrusion punches 10, 11. The moulding tool 15 (extrusion die) is fed by the separate material flows. The moulding cavity 14 provides a welding chamber in order to join the partial strands of the materials by the action of pressure and temperature.

The extrusion punches 10, 11 move the press material into the material billets 8, 9 depending on the individual pressing conditions either at the same speed or at different speeds in the direction of the moulding tool 15. The individual container bores 5, 6 and corresponding press disks need not have the same diameter.

In the method the material billets 8, 9 are moved comparably with the direct extrusion through the container bores 5, 6 in the direction of the moulding tool 15 (die). Here, as a result of the relative movement between the inner walls of the container bores 5, 6 and the lateral surfaces of the material billets 8, 9, large parts of the oxides and impurities of the extrusion billets are already retained. The material flows feeding the moulding cavity 14 are already sheared and only contain a small proportion of impurities. Material flows having almost clean metallic surfaces flow into the moulding cavity. These are joined in the moulding cavity 14 and emerge as a composite strand (extrusion product) through the press channel 16 from the moulding tool 15.

Depending on the individual pressing conditions provided for the individual material flows, the punch speeds can be adapted so that, according to the product specification, defined volume fractions of the individual composite partners can be achieved in the product. At the same time, a defined positioning of the boundary layer can be influenced by specifying the volume fractions.

For the case where both extrusion punches 10, 11 press at the same speed and the container bores 5, 6 have the same cross-sectional areas, a profile is pressed in which the composite materials are pressed out adjacent to one another with the same volume flow. Due to a specifically adjustable individual process temperature for the two material billets 5, 6, composite flat profiles can be produced from the respective container bores 5, 6 both from material pairs having small and also large differences in the forming resistance.

For the case where both materials 2, 3 should be present in variously large volume fractions in the extruded product 1, different volume flows are obtained for each material (hybrid partner) when maintaining the container geometry. This is taken into account by adapting the billet length combined with two extrusion punches travelling at different speeds. For this purpose it is necessary that both extrusion punches can be moved in a path-controlled manner. In order to be able to control the extrusion punches independently, the extruder can have a separate hydraulic system for movement of the extrusion punches 10, 11.

In the embodiments described individual ones or several of the following advantages can be achieved compared with known extrusion methods: thermal and tribological decoupling of the material partners; adjustability of various billet insertion temperatures; separate control of flow rates of the material partners; individual adaptation of the necessary process variables; and specific steering of the material flows for variable volume ratios (load/function-adapted cross-sections).

The method makes it possible to produce metallic material composites within a single solid forming step. By using separately controllable extrusion punches and by means of the possibility of achieving different container bores (punch receptacles), the flow of the material partners with significantly different flow stresses can be adjusted in such a manner that a defined material arrangement (volume ratio of the material partners or wall thickness of the material partners, formation of the boundary layer) can be set over the complete profile length of the extruded product 1.

The features disclosed in the preceding description, the claims and the drawing can be important both individually and also in any combination for implementing the various embodiments.

1. Method for producing an extruded product, comprising
providing an extrusion device comprising
a container;
a first container bore, formed in the container and in which a first extrusion punch is arranged,
a second container bore, formed in the container separately from the first container bore and in which a second extrusion punch is arranged; and
a moulding tool with a moulding cavity, which are connected to the first and the second container bore;
arranging a first material billet made of a first material in the first container bore;
arranging a second material billet made of a second material which differs from the first material in the second container bore; and
extruding an extruded product in which the first and the second material are connected in a form-fitting and integrally bonded manner, comprising the following:
feeding the first extrusion punch in the first container bore in such a manner that the first material is thereby pressed into the moulding cavity of the moulding tool and thereby formed;
feeding the second extrusion punch in the second container bore in such a manner that the second material is thereby pressed into the moulding cavity of the moulding tool and thereby formed; and
joining the first and second material in a form-fitting and integrally bonded manner to form an extruded product in the moulding tool,
wherein a first feeding during feeding of the first extrusion punch in the first container bore and a second feeding during feeding of the second extrusion punch in the second container bore are controlled independently of one another.

2. The method according to claim 1, characterized in that the connecting in a integrally bonded and form-fitting manner in the moulding tool is made between the first and second material.

3. Method according to claim 1, characterized in that the first and the second material are introduced into the moulding cavity at a different flow rate.

4. Method according to claim 1, characterized in that the feeding of the first extrusion punch in the first container bore is carried out at a first feed rate and the feeding of the second extrusion punch in the second container bore is carried out at a second feed rate which differs from the first feed rate.

5. Method according to claim 1, characterized in that during movement in the first container bore the first extrusion punch is driven by means of a first actuator and during movement in the second container bore the second extrusion punch is driven by means of a second actuator which is formed and controllable separately from the first actuator.

6. Method according to claim 1, characterized in that an extrusion profile is produced as an extruded product.

7. Method according to claim 1, characterized in that an extrusion device is provided in which the first container bore has a first cross-section and the second container bore has a second cross-section which differs from the first cross-section, transverse to the respective feed direction.

8. Method according to claim 1, characterized in that an extrusion device is provided in which the first container bore has the first cross-section and the second container bore has the second cross-section which is the same as the first cross-section, transverse to the respective feed direction.

9. Method according to claim 1, characterized in that an extrusion device is provided in which, transverse to the respective feed direction, the first container bore has a first circular transverse section, and the second container has a second circular cross section.

10. Method according to claim 1, characterized in that an extrusion device is provided in which the first container bore and the second container bore are sealed with respect to one another.

11. Device for producing an extruded product, comprising
a container;
a first container bore which is formed in the container and in which an extrusion punch is arranged;
a second container bore which is formed in the container separately from the first container bore and in which a second extrusion punch is arranged; and
a moulding tool with a moulding cavity which is connected to the first and the second container bore in such a manner that during extrusion by means of feeding the first extrusion punch in the first container bore and feeding the second extrusion punch in the second container bore, a first material of a first material billet from the first container bore and a second material of a second material billet which differs from the first material can be introduced into the moulding cavity from the second container bore to produce an extruded product in which the first and the second material are connected in a form-fitting and integrally bonded manner,
wherein a first feed during feeding of the first extrusion punch in the first container bore and a second feed during feeding of the second extrusion punch in the second container bore can be controlled independently of one another.
